(19) United States
(12) Patent Application Publication
(10) Pub. No.: US 2003/0221139 A1
(43) Pub. Date: Nov. 27, 2003

(54) Software troubleshooting method for manufacturing facility

(75) Inventors: Lee-Chung Lin, Pintung (TW); Fu-Kun Yeh, Pingtung (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/154,469

(22) Filed: May 23, 2002

(51) Int. Cl. H04L 1/22

(52) U.S. Cl. 714/4

(57) ABSTRACT

Within a method for operating a software product within a manufacturing facility, there is provided within an information system within the manufacturing facility a troubleshooting utility which is continuously updated to provide a series of updated troubleshooting procedures for the software product. By continuously updating the troubleshooting utility, a malfunction with the software product may be more efficiently addressed.

### BACKGROUND OF THE INVENTION

1. Field of the Invention

The present invention relates generally to methods for operating software products employed for operating manufacturing facilities. More particularly, the present invention relates to methods for efficiently operating software products employed for operating manufacturing facilities.

2. Description of the Related Art

Manufacturing facilities which are employed for manufacturing complex products, such as in particular integrated circuits, generally employ various software products to assist in providing more efficient and economical operation of the manufacturing facilities. Such software products are often dedicated towards individual management functions within a manufacturing facility, such as but not limited to work in process (WIP) workload management functions, tooling management functions and personnel management functions within the manufacturing facility.

While software products are thus clearly desirable for assisting in efficient operation of manufacturing facilities, and often essential for assisting in efficient operation of manufacturing facilities, software products are nonetheless not entirely without problems for assisting in operation of manufacturing facilities. In that regard, software products are often subject to malfunction when assisting in operation of manufacturing facilities.

It is thus desirable in the art of manufacturing facility operation to provide software operation methods which efficiently address software malfunction when operating manufacturing facilities.

It is towards the foregoing object that the present invention is directed.

Various systems and methods have been disclosed within various arts for providing enhanced operation of software products.

Several of the systems and methods are directed towards troubleshooting systems and methods as directed towards operating software products. Specific examples of such troubleshooting systems and methods are provided within: (1) Ahmad, in U.S. Pat. No. 6,029,258; and (2) Beyda et al., in U.S. Pat. No. 6,260,160, the disclosures of both of which are incorporated herein fully by reference.

Desirable in the art of manufacturing facility operation are software operation methods which efficiently address software malfunction when operating manufacturing facilities.

It is towards the foregoing object that the present invention is directed.

### SUMMARY OF THE INVENTION

A first object of the present invention is to provide a software operation method for operating a software product when operating a manufacturing facility.

A second object of the present invention is to provide a software operation method in accord with the first object of the present invention, wherein the software operation method efficiently addresses software malfunction when operating the software product when operating the manufacturing facility.

In accord with the objects of the present invention, there is provided a method for operating a software product for use within a manufacturing facility.

In accord with the method of the present invention, there is first provided a manufacturing facility comprising: (1) an information system having operating therein a minimum of one software product supplied by a minimum of one software supplier; (2) a troubleshooting utility for troubleshooting a malfunction with the minimum of one software product, the troubleshooting utility being associated with the information system; and (3) a communications portal also associated with the information system and the troubleshooting utility. Within the method, there is updated continuously, through the communications portal, the troubleshooting utility to provide an updated series of troubleshooting procedures for the minimum of one software product. Within the method, there is also encountered within the manufacturing facility a minimum of one software malfunction associated with the minimum of one software product. Finally, within the method, there is addressed the minimum of one software malfunction while consulting with the updated series of troubleshooting procedures.

The present invention provides a software operation method for operating a software product when operating a manufacturing facility, wherein the software operation method efficiently addresses software malfunction when operating the software product when operating the manufacturing facility.

The present invention realizes the foregoing object by employing when operating the software product (or preferably multiple software products) within the manufacturing facility a troubleshooting utility which is continuously updated through a communications portal such that a series of updated troubleshooting procedures (preferably for the multiple software products) is continuously available for addressing software malfunction within the manufacturing facility.

### BRIEF DESCRIPTION OF THE DRAWINGS

The objects, features and advantages of the present invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic block diagram of a manufacturing facility within which may be operated a software product in accord with the method of the present invention.

FIG. 2 shows a schematic process flow diagram illustrating successive process steps in accord with the method of the present invention.

### DESCRIPTION OF THE PREFERRED EMBODIMENT

The present invention provides a software operation method for operating a software product when operating a manufacturing facility, wherein the software operation method efficiently addresses software malfunction when operating the software product when operating the manufacturing facility.

The present invention realizes the foregoing object by employing when operating the software product within the manufacturing facility a troubleshooting utility which is continuously updated through a communications portal such that a series of updated troubleshooting procedures is available for addressing software malfunction within the manufacturing facility.

Although the preferred embodiment of the present invention provides particular value within the context of operating a software product for use within a semiconductor integrated circuit microelectronic fabrication facility, the present invention is not intended to be so limited. Rather the present invention may be employed for operating software products within manufacturing facilities including but not limited to chemical manufacturing facilities, mechanical manufacturing facilities and electrical (including electronic and microelectronic) manufacturing facilities. With respect to microelectronic manufacturing facilities, the present invention may be employed with respect to integrated circuit microelectronic manufacturing facilities, ceramic substrate microelectronic manufacturing facilities, solar cell manufacturing facilities and image array (sensor and display) microelectronic manufacturing facilities.

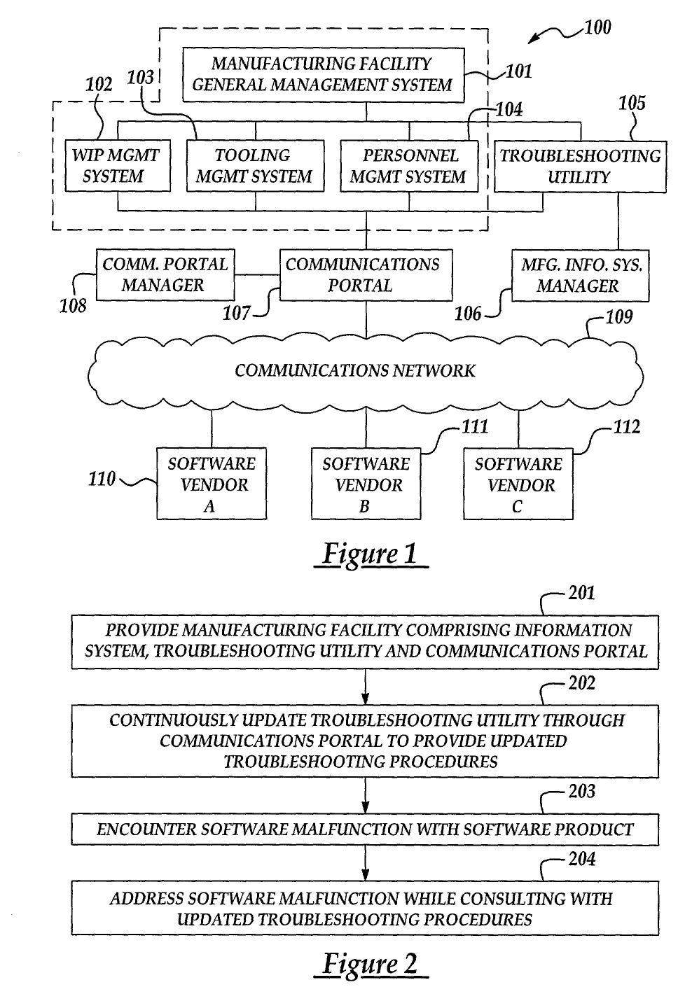

Referring now to FIG. 1, there is shown a schematic block diagram of a manufacturing facility within which may be operated a software product in accord with the method of the present invention.

Shown in FIG. 1 is a manufacturing information and control system 100 comprising in a first instance a manufacturing facility general management system 101 which provides for general management of a manufacturing facility. Similarly with other components as illustrated within the manufacturing information and control system 100, the manufacturing facility general management system 101 is a computer operated system which relies upon a software product, which in turn may be subject to malfunction.

As is further illustrated within the schematic block diagram of FIG. 1, within the manufacturing information and control system 100, the manufacturing facility general management system 101 in turn manages and controls a work in process (WIP) management system 102, a tooling management system 103 and a personnel management system 104, each of which is also a computer operated system which relies upon a software product, which in turn may be subject to malfunction. The foregoing three management systems are provided within the preferred embodiment of the present invention for illustrative purposes, and they are not intended as inclusive of all management systems which may be operative and controlled within a manufacturing facility in accord with the present invention. Similarly, each of the components within the management information and control system 100, as well as the work in process (WIP) management system 102, the tooling management system 103 and the personnel management system 104, will also have associated therewith computing hardware, databases, operating systems, connecting interfaces and applications software as are otherwise conventional or unconventional in the art of manufacturing facility management.

Also illustrated within the schematic block diagram of FIG. 1 is a troubleshooting utility 105 which is associated with the management information and control system 100. The troubleshooting utility 105 is interrelated most particularly with the work in process management system 102, the tooling management system 103 and the personnel management system 104, but is also associated with the manufacturing facility general management system 101. The troubleshooting utility 105 is further independently controlled by a manufacturing information systems manager 106, for purposes of assuring proper operation and content of the troubleshooting utility 105, which is also a software product.

Also connected with and associated with the management information and control system 100 is a communications portal 107 further in turn connected with a communications network 109. The communications portal 107 is in turn controlled by a communications portal manager 108 for purposes of assuring continuity of communications through the communications portal 107. Within the preferred embodiment of the present invention, the communications network 109 may be a local area network (LAN) communications network or a wide are network (WAN) communications network. Typically and preferably, the communications network 109 is an Internet distributed communications network.

Finally there is illustrated within the schematic block diagram of FIG. 1 block 110, block 111 and block 112 which provide for software vendor A, software vendor B and software vendor C access to the communications portal 107 through the communications network 109.

As is understood by a person skilled in the art, the schematic block diagram of FIG. 1 provides a preferred but not necessarily exclusive disposition of components in accord with the present invention. Significant to the present invention is software vendor A 110, software vendor B 111 and software vendor C 112 access to the troubleshooting utility 105 through the communications network 109 and the communications portal 107.

Referring now to FIG. 2, there is shown a schematic process flow diagram illustrating operation of a software product in accord with the method of the present invention, within the context of the manufacturing facility whose schematic block diagram is illustrated in FIG. 1.

As is illustrated within the process flow diagram of FIG. 2, and in accord with the block which corresponds with reference numeral 201, there is provided a manufacturing facility comprising an information system, a troubleshooting utility and a communications portal, in accord with the management information and control system 100, the troubleshooting utility 105 and the communications portal 107 as illustrated within the schematic block diagram of FIG. 1.

In accord with the block which corresponds with reference numeral 202, troubleshooting procedures for a software product (or preferably multiple software products) operating within the information system are continuously updated through the communications portal to provide a series of updated troubleshooting procedures. Such continuous updating is preferably effected directly by the software supplier (ore preferably multiple software suppliers) for the at least one software product (or preferably multiple software products), although the manufacturing information systems manager 105 and the communications portal manager 108 may also participate in or alternatively effect proper update of troubleshooting procedures. The updates may be provided employing methods and means, such as file transfer methods and means as are conventional or unconventional in the art of manufacturing facility management.

In accord with the block which corresponds with reference numeral 203, there is then encountered a software malfunction with the software product operating within the information system.

Finally, in accord with the block which corresponds with reference numeral 204, the software malfunction is addressed while consulting the updated troubleshooting procedures. Typically and preferably, the software malfunction will be addressed by a software engineer associated with the manufacturing information system manager 106 as illustrated in FIG. 1.

As is understood by a person skilled in the art, the method of the present invention in accord with the schematic process flow diagram of FIG. 2 and the schematic block diagram of FIG. 1 provides for more efficient resolution of software malfunctions since troubleshooting procedures for resolution thereof are continuously updated. Similarly, since there will typically be multiple software products operating within a manufacturing facility, the presence of a complete set of completely updated troubleshooting procedures on-line in a single location within a manufacturing facility also assists in providing for efficient resolution of software malfunctions.

As is understood by a person skilled in the art, the preferred embodiment of the present invention is illustrative of the present invention rather than limiting of the present invention. Revisions and modifications may be made to components and systems employed within the context of the preferred embodiment of the method of the present invention, while still providing a method in accord with the present invention, further in accord with the accompanying claims.

What is claimed is:

1. A method for operating a software product for use within a manufacturing facility comprising:
providing a manufacturing facility comprising:
an information system having operating therein a minimum of one software product supplied by a minimum of one software supplier;
a troubleshooting utility for troubleshooting a malfunction with the minimum of one software product, the troubleshooting utility being associated with the information system; and
a communications portal also associated with the information system and the troubleshooting utility;
updating continuously, through the communications portal, the troubleshooting utility to provide an updated series of troubleshooting procedures for the minimum of one software product;
encountering within the manufacturing facility a minimum of one software malfunction associated with the minimum of one software product; and
addressing the minimum of one software malfunction while consulting with the updated series of troubleshooting procedures.

2. The method of claim 1 wherein the manufacturing facility is selected from the group consisting of chemical manufacturing facilities, mechanical manufacturing facilities and electrical manufacturing facilities.

3. The method of claim 1 wherein the communications portal is connected to a distributed communications network.

4. The method of claim 3 wherein the distributed communications network is an Internet distributed communications network.

5. The method of claim 1 wherein the continuous updating of the troubleshooting utility is effected by the minimum of one software supplier.

6. A method for operating a software product for use within a microelectronic manufacturing facility comprising:
providing a microelectronic manufacturing facility comprising:
an information system having operating therein a minimum of one software product supplied by a minimum of one software supplier;
a troubleshooting utility for troubleshooting a malfunction with the minimum of one software product, the troubleshooting utility being associated with the information system; and
a communications portal also associated with the information system and the troubleshooting utility;
updating continuously, through the communications portal, the troubleshooting utility to provide an updated series of troubleshooting procedures for the minimum of one software product;
encountering within the manufacturing facility a minimum of one software malfunction associated with the minimum of one software product; and
addressing the minimum of one software malfunction while consulting with the updated series of troubleshooting procedures.

7. The method of claim 6 wherein the microelectronic manufacturing facility is selected from the group consisting of integrated circuit manufacturing facilities, ceramic substrate manufacturing facilities, solar cell manufacturing facilities and image array manufacturing facilities.

8. The method of claim 6 wherein the communications portal is connected to a distributed communications network.

9. The method of claim 8 wherein the distributed communications network is an Internet distributed communications network.

10. The method of claim 6 wherein the continuous updating of the troubleshooting utility is effected by the minimum of one software supplier.
